(19) United States
(12) Patent Application Publication
(10) Pub. No.: US 2009/0021327 A1
(43) Pub. Date: Jan. 22, 2009

(54) ELECTRICAL FILTER SYSTEM USING MULTI-STAGE PHOTONIC BANDGAP RESONATOR

(76) Inventors: Julie Anne LaComb, West Greenwich, RI (US); Ronald LaComb, West Greenwich, RI (US)

Correspondence Address: NAVAL UNDERSEA WARFARE CENTER;DIVISION NEWPORT, 1176 HOWELL STREET, CODE 000C, NEWPORT, RI, 02841, US

(21) Appl. No.: 11/779,458

(22) Filed: Jul. 18, 2007

(51) Int. Cl. H01P 1/20

(52) U.S. Cl. 333/202

(57) ABSTRACT

An electrical filter system includes a transmission line and three or more separated photonic bandgap (PBG) structures positioned successively therealong.

### STATEMENT OF GOVERNMENT INTEREST

The invention described herein may be manufactured and used by or for the Government of the United States of America for governmental purposes without the payment of any royalties thereon or therefore.

### BACKGROUND OF THE INVENTION

(1) Field of the Invention

The present invention relates generally to electrical filters, and more particularly to an electrical filter system that incorporates a multi-stage photonic bandgap resonator along a transmission line to create a wide pass-band within the stop-band of the filter system.

(2) Description of the Prior Art

The electromagnetic wave energy carried by transmission lines must frequently be modified to suit a particular application. For example, microstrip transmission lines can incorporate a photonic bandgap (PBG) structure in order to exhibit stop-band characteristics that act to filter the electromagnetic wave energy propagated by the transmission line. As is known in the art, a photonic bandgap structure is a periodic arrangement of “defects” (e.g., pits or holes formed in layer of a device) that prevents the propagation of all electromagnetic waves within a particular frequency band. The defects introduce electrical frequency stop-bands much like a Bragg grating or crystal lattice structure introduces stop-bands in an optical transmission system. The spacing of the photonic bandgap structure's periodic defects determines the stop-band frequencies. The size of the defects determines the width of the stop-band region.

Photonic bandgap structures have also been used to create mirrors that form a Fabry-Perot resonator. The “mirror” is formed by two photonic bandgap structures separated by a gap. This approach can be used to construct microwave resonators for a variety of applications to include filters, oscillators, frequency meters and tuned amplifiers. However, this configuration of two photonic bandgap structures separated by a gap only provides for a very narrow pass-band within the stop-band of the photonic bandgap structure. Thus, this configuration is limited to use in narrow pass-band applications and requires the maintenance of tight manufacturing tolerances so that the narrow pass-band is accurately constructed at the proper frequencies. What is needed is a configuration that provides a wider pass-band with a simpler construction.

### SUMMARY OF THE INVENTION

Accordingly, it is an object of the present invention to provide an electrical filter system that can utilize photonic bandgap structures in a way that provides for relatively wide pass-bands.

Other objects and advantages of the present invention will become more obvious hereinafter in the specification and drawings.

In accordance with the present invention, an electrical filter system includes a transmission line and three or more photonic bandgap (PBG) structures positioned successively therealong. A gap separates adjacent PBG structures. The size of the gap and number of PBG structures defines/controls the pass-band of the filter system.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of an electrical filter system in accordance with an embodiment of the present invention;

FIG. 2 is a side schematic view of an electrical filter system of the present invention in which the photonic bandgap (PBG) structures are incorporated in a dielectric portion of the filter system's transmission line; and

FIG. 3 is a side schematic view of an electrical filter system of the present invention in which the photonic bandgap (PBG) structures are incorporated in a conductive portion of the filter system's transmission line.

### DETAILED DESCRIPTION OF THE INVENTION

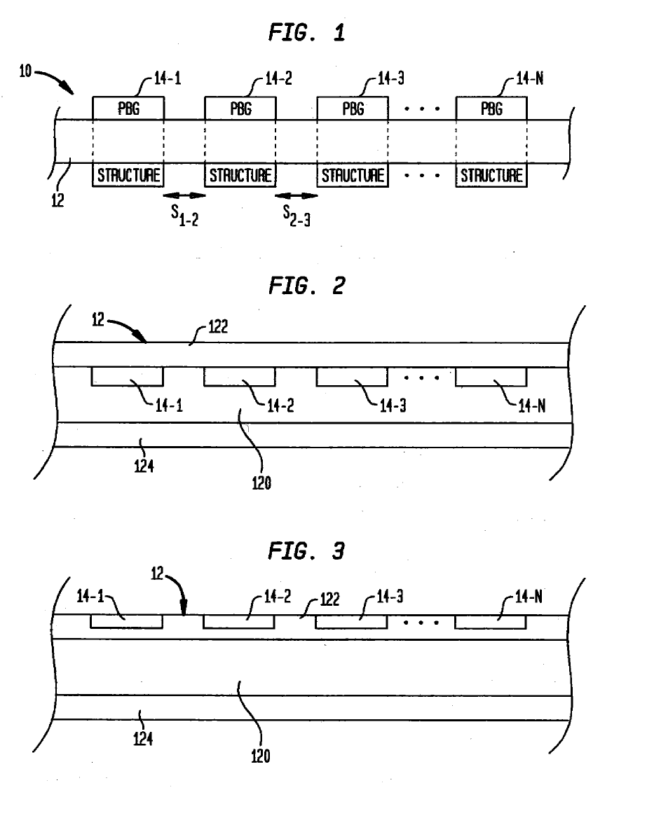

Referring now to the drawings and more particularly to FIG. 1, an electrical filter system in accordance with the present invention is shown and is referenced generally by numeral 10. As used herein, the term “filter” is used in the conventional way to define a structure/system that suppresses certain frequencies (i.e., defined as stop-band frequencies) while passing other frequencies (i.e., defined as pass-band frequencies) of an electromagnetic wave transmission.

Filter system 10 includes a portion of a transmission line 12 and three or more photonic bandgap (PBG) structures 14-1, 14-2, . . . , 14-N positioned along transmission line 12 and separated from one another. The three or more PBG structures 14-1, 14-2, . . . , 14-N are positioned in a deliberate periodic pattern separated by gaps to define/control the pass-band frequency attributes of filter system 10 as will be explained further below.

Transmission line 12 is any conventional medium for transmitting electromagnetic wave energy therealong to include, for example, microstrips, coaxial line, etc., the choice of which is not a limitation of the present invention. In general, a transmission line has two conductors (typically referred to as a centerline and a ground or ground plane) separated by a dielectric. PBG structures 14-1, 14-2, . . . , 14-N could be incorporated in either one of the transmission line's conductors (i.e., either the centerline or ground plane) or the transmission line's dielectric without departing from the scope of the present invention. For example, FIG. 2 illustrates PBG structures 14-1, 14-2, . . . , 14-N incorporated in a dielectric medium 120 disposed between a centerline conductor 122 and a ground plane 124 of transmission line 12. In FIG. 3, PBG structures 14-1, 14-2, . . . , 14-N are incorporated in centerline conductor 122. It is further to be understood that the particular construction and configuration of each PBG structure is not a limitation of the present invention as any well-known PBG construction/configuration technology can be used without departing from the scope of the present invention.

As mentioned above, the three or more of PBG structures 14-1, 14-2, . . . , 14-N are used to define/control the pass-band of filter system 10. More specifically, each successive pair of the PBG structures defines a single-stage PBG resonator, i.e., PBG structures 14-1 and 14-2 define a single-stage PBG resonator, PBG structures 14-2 and 14-3 define another single-stage PBG resonator, etc. The spacing or gap between adjacent PBG structures defines a narrow pass-band for the particular pair. For example, gap S₁₋₂ defines the narrow pass-band associated with the single-stage PBG resonator defined by PBG structures 14-1 and 14-2. However, it has been found that the overall pass-band of filter system 10 is widened by using a multi-stage PBG resonator that includes at least two pair of single-stage PBG resonators. Thus, at a minimum, the present invention requires three successively positioned PBG structures (e.g., PBG structures 14-1, 14-2 and 14-3) to define two single-stage PBG resonators.

The overall pass-band of filter system 10 is defined/controlled by (i) the gaps associated with each single-stage PBG resonator (e.g., S₁₋₂, S₂₋₃, etc.), and (ii) the number of PBG structures used to define the multi-stage PBG resonator. The gaps between the PBG structures can be the same or different throughout filter system 10.

The advantages of the present invention are numerous. An electrical filter system utilizing a multi-stage PBG resonator as currently disclosed can achieve a wide frequency pass-band. This will increase the number and type of electric filter applications that can utilize PBG structures.

It will be understood that many additional changes in the details, materials, steps and arrangement of parts, which have been herein described and illustrated in order to explain the nature of the invention, may be made by those skilled in the art within the principle and scope of the invention as expressed in the appended claims.

What is claimed is:

1. An electrical filter system, comprising:
a transmission line for supporting electromagnetic wave transmission therealong; and
at least three photonic bandgap (PEG) structures positioned successively along said transmission line with a gap separating adjacent ones of said PBG structures.

2. An electrical filter system as in claim 1 wherein said transmission line includes conductive and dielectric portions, and wherein said PBG structures are incorporated in said dielectric portion of said transmission line.

3. An electrical filter system as in claim 1 wherein said transmission line includes conductive and dielectric portions, and wherein said PBG structures are incorporated in said conductive portion of said transmission line.

4. An electrical filter system as in claim 1 wherein each said gap is identical.

5. An electrical filter system as in claim 1 wherein said transmission line is selected from the group consisting of microstrips and coaxial lines.

6. An electrical filter system, comprising:
a transmission line for supporting electromagnetic wave transmission therealong; and
a multi-stage photonic bandgap (PBG) resonator defining at least two pair of single-stage PBG resonators positioned successively along said transmission line.

7. An electrical filter system as in claim 6 wherein said transmission line includes conductive and dielectric portions, and wherein said multi-stage PBG resonator is incorporated in said dielectric portion of said transmission line.

8. An electrical filter system as in claim 6 wherein said transmission line includes conductive and dielectric portions, and wherein said multi-stage PBG resonator is incorporated in said conductive portion of said transmission line.

9. An electrical filter system as in claim 6 wherein said transmission line is selected from the group consisting of microstrips and coaxial lines.

10. An electrical filter system, comprising:
a transmission line for supporting electromagnetic wave transmission therealong; and
at least three photonic bandgap (PBG) structures with a gap separating adjacent ones of said PBG structures, said PBG structures positioned successively along said transmission line to control pass-band frequency attributes of said electrical filter system.

11. An electrical filter system as in claim 10 wherein said transmission line includes conductive and dielectric portions, and wherein said PBG structures are incorporated in said dielectric portion of said transmission line.

12. An electrical filter system as in claim 10 wherein said transmission line includes conductive and dielectric portions, and wherein said PBG structures are incorporated in said conductive portion of said transmission line.

13. An electrical filter system as in claim 10 wherein each said gap is identical.

14. An electrical filter system as in claim 10 wherein said transmission line is selected from the group consisting of microstrips and coaxial lines.
